(19) United States
(12) Patent Application Publication
(10) Pub. No.: US 2011/0034712 A1
(43) Pub. Date: Feb. 10, 2011

(54) METHOD OF EXTRACTING ESSENTIAL OIL FROM BIOMASS WASTES AND A DEVICE THEREOF

(76) Inventor: Wei Chih LIN, Taichung (TW)

Correspondence Address: WENDEROTH, LIND & PONACK, L.L.P., 1030 15th Street, N.W.,, Suite 400 East, Washington, DC, 20005-1503, US

(21) Appl. No.: 12/537,587

(22) Filed: Aug. 7, 2009

(51) Int. Cl. C11B 1/00; C10B 57/04

(52) U.S. Cl. 554/22; 202/105

(57) ABSTRACT

A method of extracting essential oil from biomass wastes puts biomass wastes, such as wood residuals, wood chips or other plants, in an air-tight oxygen-free reaction vessel to be heated up indirectly, for conducting a thermal pyrolysis cracking reaction (i.e. dry distillation); and guides volatile gas which is distilled when the processed wastes disintegrate, into a condenser to be condensed as liquid which is then separated into water and oil through an oil-water separation tank. Whereas, non-liquefied gas is discharged outside after deodorizing, and residuals in the reaction vessel are processed with high-temperature dry distillation once to become activated carbons. In processing, temperature and pressure in the reaction vessel are controlled in multiple phases, along with using a suction pump of a changeable speed and a changeable flow rate to suck out air in high speed in phases, to keep internal pressure of the reaction vessel at a low pressure condition, thereby shortening a processing time and acquiring high quality essential oil and activated carbons as by-products.

The present invention also includes a system device to implement this method. In the oil-water separation tank of this device, an ultrasonic generator is provided to re-disintegrate tars, which improves quality of the oil products.

### BACKGROUND OF THE INVENTION

a) Field of the Invention

The present invention relates to a method of extracting essential oil from biomass wastes and a device thereof, and more particularly to a processing method which executes dry distillation to biomass wastes such as wood wastes, wood chips or other plants in an air-tight reaction vessel under an oxygen-free condition, in order to acquire high quality essential oil and residuals which are activated carbons as by-products; and a system device which utilizes this processing method.

b) Description of the Prior Art

Ordinary so-called essential oil is primarily plant-type essential oil which is extracted from branches, leaves, roots, stems, skins, chips, fruits, buds and resins of the plants, is usually in a liquid state and is lighter than water that the essential oil is different from grease. An ingredient of the essential oil generally refers to hydrocarbon in a form of (C₅H₈)ₙ, but primarily terpenes and derivatives like aromatic hydrocarbons, alcohols, aldehydes and ketones having C₁₀H₁₆, C₁₅H₂₄ and C₂₀H₃₂. There are usually three methods to extract the essential oil: (1) the steam distillation method (2) the press method and (3) the solvent method; and the most commonly used one is the steam distillation method.

As being provided with strong adsorption, deodorization, decolorizing and filtering capabilities to inorganic or organic materials or colloidal particles in solution, activated carbons have been widely applied in food product, medicine, grease, gasoline and water processing industries, and demands are increasing year by year. An ordinary method for producing the activated carbons includes using wood, wood chips, coconut shells, bagasse, coal and peat as raw materials, which are carbonized and then activated to form the activated carbons. The activation methods include (1) the steam activation method (2) the chemical activation method and (3) other methods. In the steam activation method, the carbonized raw materials are smashed and then are activated in a boiler with superheated steam at temperature of more than 800° C. In the typical chemical activation method, the smashed raw materials are submerged in solution of zinc chloride and then are activated along with calcinations and carbonization; whereas chemicals are removed by washing with water after the activation. As for other methods, the raw materials are filled with inert gas such as air, carbon dioxide or nitrogen, and then are calcinated and activated.

The aforementioned production methods for extracting the essential oil and the activated carbons utilize two different equipment and two different manufacturing processes to implement independently. Hence, very large equipment space will be needed, manufacturing time will be long, much energy will be wasted and more operation personnel will be required, thereby being very difficult to comply with economic benefits.

The Taiwanese New Utility Patent Publication No. 477239 discloses a simple essential oil extraction device which is a small-scaled easy assembling device utilizing the steam distillation method to extract the essential oil from aromatic flowers, is suitable for laboratory use or personal DIY use and does not aim for industrial mass production.

On the other hand, the Taiwanese New Utility Patent No. M266969 discloses an improved structure of an essential oil extraction device. This device is basically about the same as that disclosed by the aforementioned New Utility Patent Publication No. 477239. The only differences are that an upper part of an inner tube of a condensing tube is formed with a steam chamber of larger diameter, a lower part is formed with a oil gathering chamber of reduced diameter, and a lower end of this inner tube is connected with an essential oil reverse tube which is connected to a gas pipe coming from a flask.

The Taiwanese New Utility Patent Publication No. 481045 discloses a movable essential oil extraction device. This device still uses the steam distillation method as the aforementioned two patents. However, the device is middle-scaled and is movable.

Besides, the Taiwanese Invention Patent Publication No. 51708 also discloses a method which uses waste rubber to produce gasoline, diesel oil and carbon black. As disclosed by the aforementioned Patent Publication No. 462984, the method utilizes very large factory equipment and a complicated operating system to refine waste tires into gasoline, diesel oil and carbon black by thermal pyrolysis cracking and catalytic cracking.

Moreover, the Taiwanese Invention Publication No. 462984 discloses a method and a device for continuously recycling and refining waste tires into activated carbons. This invention is suitable to process tires in a large scale to acquire combustible fuel, combustible gas and carbon black. The combustible fuel and the combustible gas provide for the fuels used in a thermal pyrolysis cracking furnace and an activation furnace, and the carbon black is removed with impurities, smashed and guided into the activation furnace to be activated into activated carbons in grains.

The latter two patents described above contribute a certain degree to resource recycling and environmental protection; yet, equipment cost is huge and they cannot apply to the production of essential oil.

Furthermore, the Taiwanese Invention Patent Publication No. 2008 19525 discloses a production system and method for biomass energy activated carbons, wherein processed raw materials can be carbonized and activated as the activated carbons in the system. This invention is featured by that waste heat generated by a carbonization-activation furnace is used to heat up a boiler producing high-temperature steam which is guided into the carbonization-activation furnace to activate the carbonized raw materials.

However, none of the aforementioned prior arts discloses a technology that in a same time when a single system extracts the essential oil from the biomass materials, the remaining solid-state carbonized materials can be activated to acquire the activated carbons, nor discloses operating conditions at which various temperature and pressure are controlled during the thermal pyrolysis cracking process.

### SUMMARY OF THE INVENTION

The primary object of the present invention is to provide a method of extracting essential oil from biomass wastes. The method particularly puts plant-type biomass wastes in an air-tight oxygen-free reaction vessel for dry distillation (i.e., thermal pyrolysis cracking) to acquire plant-type oil or essential oil, and in a same time, to get activated carbons as by-products.

A second object of the present invention is to provide a method by which essential oil can be extracted from biomass wastes and activated carbons can be obtained at a same time. In a manufacturing process, temperature and pressure in a reaction vessel are controlled in phases, and air is sucked out in a short time by a high-speed suction pump depending upon internal pressure and distilled substance in the reaction vessel, so as to maintain at low pressure and prevent the distilled substance from staying in the reaction vessel for too long that the distilled substance is scorched excessively. Therefore, a processing time can be shortened, essential oil of high quality and high yield and activated carbons as by-products can be acquired.

A third object of the present invention is to provide a device which implements the aforementioned method of extracting essential oil from biomass wastes. The device includes an air-tight reaction vessel having a lock-type inner vessel, which is used to heat up biomass raw materials indirectly to be thermally disintegrated, a condenser which condenses thermally disintegrated and distilled gas as liquid, a separation tank which separates condensed liquid into water and oil, and a suction pump which is provided at an outlet port of the separation tank.

A fourth object of the present invention is to provide a device which implements the aforementioned method, wherein the suction pump which is located at the outlet port of the separation tank is a suction pump with a changeable flow rate and a changeable rotation speed, such that when internal pressure of the reaction vessel rises up to exceed pre-determined pressure, a suction rate will be increased quickly, so as to reduce the internal pressure in a short time to keep at low pressure, thereby promoting evaporation and avoiding distilled substance to be staying in the reaction vessel for too long that the distilled substance is scorched excessively.

A fifth object of the present invention is to provide a device which implements the aforementioned method, wherein an interior of the separation tank is provided with an ultrasonic generator to facilitate tars to be re-disintegrated, thereby improving quality and capacity of oil products.

A sixth object of the present invention is to provide a device which implements the aforementioned method, wherein an exhaust pipe of the separation tank can be further connected with a second condenser and a mixing tank if necessary, such that after non-liquefied gas is further condensed at lower temperature as oil, the oil is mixed with the oil which is guided into the mixing tank from the separation tank, thereby increasing an extraction rate.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of components of a first embodiment of a system which extracts essential oil from biomass wastes, according to the present invention.

FIG. 2 shows a schematic view of components of a second embodiment of an essential oil extraction system, according to the present invention.

FIG. 3 shows a schematic view of components of a third embodiment of an essential oil extraction system, according to the present invention.

### DETAILED DESCRIPTION OF THE PREFERRED EMBODIMENTS

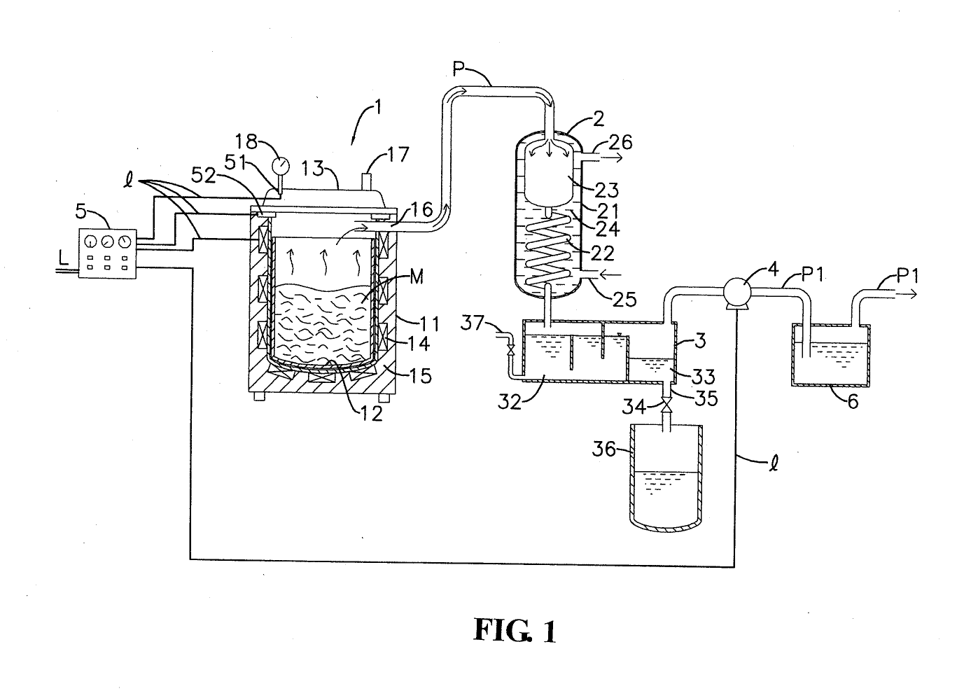

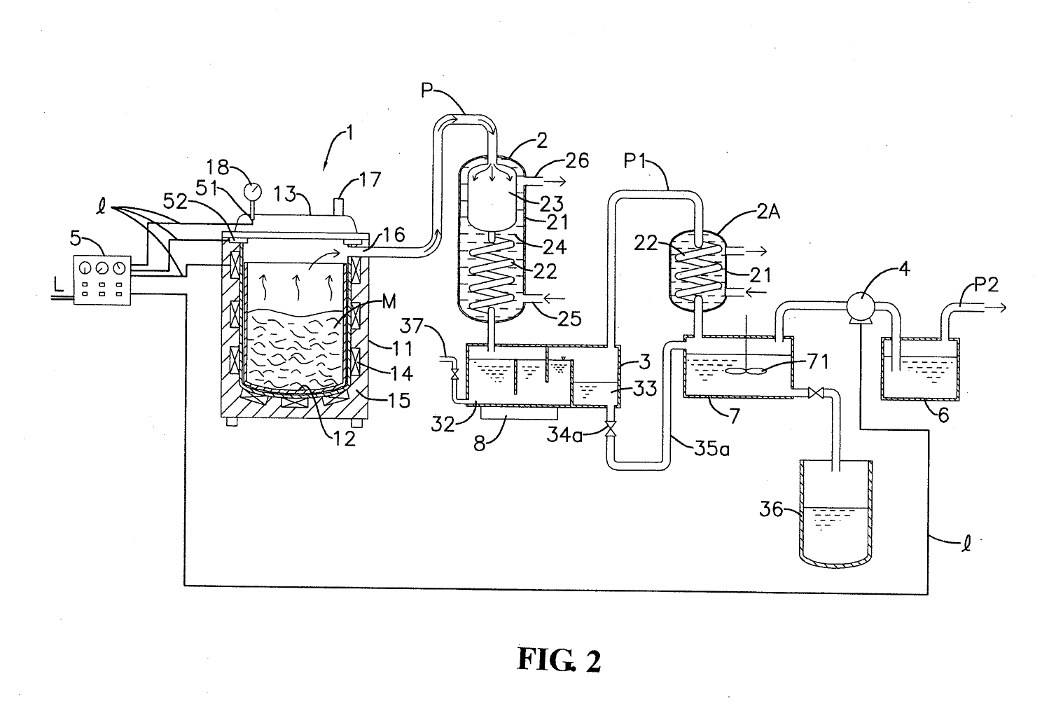

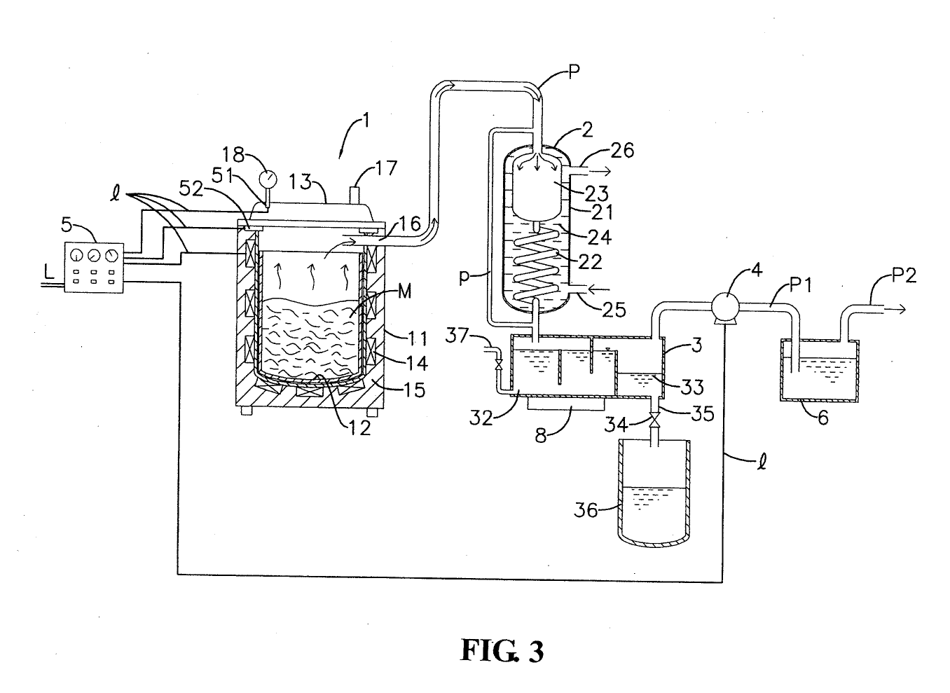

In the drawings, FIG. 1 shows a schematic view of components of a first embodiment of a system which extracts essential oil from biomass wastes, according to the present invention; FIG. 2 shows a schematic view of components of a second embodiment of an essential oil extraction system, according to the present invention; and FIG. 3 shows a schematic view of components of a third embodiment of an essential oil extraction system, according to the present invention.

A first embodiment of an essential oil extraction system as shown in FIG. 1 comprises a reaction vessel 1, a condenser 2, a water-oil separation tank 3, a suction pump 4 and a control booth 5 which are orderly provided downstream the reaction vessel 1 according to piping.

The reaction vessel 1 includes an exterior vessel 11 which is surrounded by an electro-thermal device 14 and a thermal insulation humectant 15, a dismountable inner vessel 12 and an air-tight cover 13 which can be tightly covered on an opening of the exterior vessel 11. A side wall at an upper part of the exterior vessel 11 is provided with a gas outlet 16 from which a gas pipe P is connected to an inlet port of the condenser 2. The cover 13 is provided with a safety valve 17 and a pressure gage 18.

The condenser 2 is provided with a sealed tank 21 and a helical or devious inner tube 22 which is emplaced inside the sealed tank 21. An end of the tank 21 is connected to an outlet port of the gas pipe P, and this outlet port is preferably formed with a gas gathering chamber 23 of large diameter. An end of the gas gathering chamber 23 is connected to an end of the aforementioned inner tube 22, and the other end of the inner tube 22 is connected to the water-oil separation tank 3. In addition, an outer peripheral wall of the tank 21 is formed with a water jacket 24 and is provided with a cooling water (or coolant) inlet 25 and outlet 26 to introduce and discharge the cooling water or coolant. The condenser 2 is not limited to the type used in the present embodiment and any suitable conventional condenser can be used, including the condenser which is not provided with the gas gathering chamber 23.

The water-oil separation tank 3 is used to separate condensate of the condenser 2 into water and oil, and an interior of the tank 3 is provided with a baffle 31 to divide the tank 3 into a liquid gathering chamber 32 and an overflow chamber 33. After the condensate has entered into the liquid gathering chamber 32, oil, which is provided with lighter specific weight and floats on top of water, overflows from the liquid gathering chamber 32 into the overflow chamber 33; whereas, non-liquefied gas, which is located above a liquid surface, is sucked out by the suction pump 4 to be discharged into atmosphere through an exhaust pipe P1. In order to prevent hot gas or smell from polluting air, it is preferably to guide gas into a water-sealed tank 6 for reducing temperature and deodorizing prior to be discharged outside.

The control booth 5 is located in the system at a place for easy monitoring and controlling. This control booth 5 is provided with a power switch, a pressure gage, a temperature gage, buttons used for adjusting and controlling internal pressure and temperature of the reaction vessel 1, and a caution light or an alarm for an abnormal condition. The control booth 5 is connected to a pressure transducer 51, a temperature transducer 52, the electro-thermal device 14 and the suction pump 4 by wires, and is of course also provided with power lines L for connection to a power source.

Hereinafter a method using the aforementioned system to extract the essential oil from the biomass wastes is described.

First, raw waste materials M, such as cypress residual branches or stems, which are cleaned, dried, smashed or chopped properly, are put into the inner vessel 12 of the reaction vessel 1, and then the reaction vessel 1 is covered tightly by the cover 13 to keep air-tight inside the reaction vessel 1. Next, the suction pump 4 is operated to suck air out of the reaction vessel 1, decreasing internal pressure of the reaction vessel 1 to 0.5˜0.8 kg/cm², in a low vacuum condition. If necessary, inert gas like nitrogen can be filled into the reaction vessel 1. Then, power is activated by the control booth 5 to heat up the electro-thermal device 14, and temperature inside the reaction vessel 1 is controlled at 150˜200° C. by a temperature control button. After a while, the raw materials M inside the reaction vessel 1 will be disintegrated to produce smoky gas which contains mostly water at 100° C. and small part of light oil. The gas flows into the gas gathering chamber 23 of the condenser 2 through the gas pipe P, and when flowing through the helical inner tube 22, is condensed as liquid by the cooling water in the water jacket 24 and next flows into the separation tank 3. At this time, when the condensate which contains mostly water flows into the liquid gathering chamber 32 until a water level exceeds a top end of the baffle 31, oil which is provided with small specific weight and floats on top of water will overflow from the liquid gathering chamber 32 to the overflow chamber 33 and be stored in this chamber. When the oil is stored to a certain quantity, a valve 34 can be opened, allowing the oil to be gathered in an oil tank 36 through an oil drain pipe 35. The water level of the liquid gathering chamber 32 is kept at a certain level by a water level gage (not shown in the drawings) or other means, and excessive water is discharged outside through a water drain pipe 37.

In the thermal pyrolysis cracking or dry distillation process, when a large amount of gas is generated inside the reaction vessel 1 that the internal pressure increases to exceed pre-determined pressure, e.g., 1.2 kg/cm², which can be identified by the pressure gage and the alarm of the control booth 5, the suction pump 4 can be controlled automatically by an electrically controlled loop or computer software (both not shown in the drawings) connected with the pressure gage or manually by an operator to rotate in high speed or to increase a flow rate and to suck out air for a short time, e.g. 1 min. to several minutes, enabling the pressurized gas to enter in a large quantity into the gas gathering chamber 23 that the internal pressure can decrease in a short time to below 0.8 kg/cm² for example, in order to keep at dry distillation in low pressure, such that when volatile substance evaporates in lower temperature, distilled substance can be prevented from staying in the reaction vessel 1 for too long that the distilled substance is scorched excessively to result in more heavy tars. When the pressure restores to the original pre-determined pressure and almost no condensate is produced continuously or gas discharge is largely reduced, reaction temperature setting is changed to 250˜350° C. for example, by the control booth 5 to implement a second phase of thermal pyrolysis cracking process, with pressure still being kept at 0.5˜0.8 kg/cm². As most water has evaporated completely in the aforementioned first phase of thermal pyrolysis cracking process, in this phase, only most high boiling point essential oil at temperature higher than 250° C. will evaporate to gas under this temperature. After flowing into the condenser 2 through the gas pipe P and is condensed as liquid, the gas will enter into the separation tank 3 and overflow to the overflow chamber 33; whereas, the non-liquefied gas is discharged through the exhaust pipe P1. Under high temperature, the pressure inside the reaction vessel 1 will still rise up following the increase of temperature and the generation of a large quantity of gas. At this time, the suction pump 4 can be controlled automatically or manually as described above to carry out a high flow-rate suction operation in a short time, allowing the internal pressure to drop timely, so as to maintain at a pre-determined low pressure state of 0.5-0.8 kg/cm2, such that the oil can evaporate more quickly and the volatile gas will not stay in the high-temperature reaction vessel 1 too long that the volatile gas is scorched excessively or the heavy tars are reconstituted. Therefore, the reaction can be executed under lower temperature and in a shorter time to assure safety, and capacity and quality of the oil products can be improved.

When there is no sign that the internal pressure of the reaction vessel 1 is rising and almost no oil is continuously produced in the separation tank 3, the second phase of reaction is accomplished. At this time, temperature can be set at 350˜500° C. for example, and a third phase of thermal pyrolysis cracking process is implemented under the internal pressure of 0.5˜0.8 kg/cm². However, at this time, only a small amount of heavy oil at a boiling point higher than 350° C. will be disintegrated as gas. As described above, after the gas has been condensed as oil through the condenser 2 and entered into the separation tank 3 for separation, the oil will overflow to the overflow chamber 33, whereas the gas is discharged outside. When executing this high-temperature thermal pyrolysis cracking process, the reaction vessel 1 is also kept at low pressure by the suction pump 4 as described above; therefore, a reaction time is shortened and safety is assured, as well as capacity and quality of the oil products are improved. When the internal pressure of the reaction vessel 1 drops down and almost no condensate and gas are produced, the second phase of thermal pyrolysis cracking process is accomplished and residuals of the raw materials M inside the inner vessel 12 form solid-state carbonized materials after going through the aforementioned three phases of dry distillation and carbonization from low temperature to high temperature. After that, temperature in the reaction vessel 1 is set at activation temperature of 500˜700° C. and intermittent short-time suction at low pressure is kept by the suction pump 4, in order to perform a fourth phase of treatment to activate the solid-state carbonized materials. At this time, only an extremely small amount of high boiling point gas, such as heavy metal, is produced. Whereas, after a certain period of time, like 1˜2 hrs, the solid-state carbonized materials will become activated carbons. Following that, the power is turned off to stop operation. When temperature inside the reaction vessel 1 reduces to normal temperature, the cover 13 is opened and the inner vessel 12 is removed outside by a crane or a chain block (not shown in the drawings) to unload the activated carbons. In addition, another inner vessel 12 which has been already loaded with the raw wastes is put into the exterior vessel 11 and then the reaction vessel 1 is covered tightly by the cover 13 that a second cycle of thermal pyrolysis cracking process can be implemented.

Accordingly, these procedures are implemented repeatedly that the oil product, such as the essential oil, can be extracted from the raw materials very efficiently with the processing time even shorter than the conventional methods. At a same time, the activated carbons can be acquired, as well.

In the thermal pyrolysis cracking process of the aforementioned embodiment, the entire process is divided into four phases which are undertaken under various temperatures. However, the aforementioned first to third phases can be also divided into more temperature gradient phases to carry out, for example, every 100° C. or 150° C. It is also feasible that if the third phase and the fourth phase are combined as one phase, and temperature is increased to more than 500° C. to execute the thermal pyrolysis cracking to heavy oil and to activate carbonized materials, after accomplishing the second phase. At this time, the processing time is about a summation of the processing times of the aforementioned third phase and fourth phase. On the other hand, the aforementioned temperature ranges and temperature gradients of each phase are only an example and these temperatures can be altered according to types, properties and shapes of raw materials for processing. Besides, the separation tank 3 is not limited to the embodiment in the drawing, all kinds of suitable conventional horizontal or vertical separation tanks can be used. Moreover, it is also feasible that the reaction vessel 1 is not provided with the inner vessel 12.

Referring to FIG. 2, it shows a second embodiment of the present invention. In the present embodiment, all parts that are equal or similar to those in the system of the first embodiment are marked by same symbols and description is omitted.

In the present embodiment, the components are basically the same as those in the aforementioned embodiment, except that the exhaust pipe P1 of the separation tank 3 is additionally connected with a second condenser 2A. An outlet port of this condenser 2A is connected to a mixing tank 7 and a bottom of the mixing tank 7 is provided with an oil drain pipe 35a and a valve 34a to guide oil in the tank into the oil tank 36. An upper part of the mixing tank 7 is provided with an exhaust pipe P2 and the suction pump 4 is provided on this exhaust pipe P2 to replace the exhaust pipe P1 of the first embodiment. In addition, at the other end of the separation tank 3 from the oil drain pipe 35, which is provided with the valve 34, to the mixing tank 7, an interior of the mixing tank 7 is provided with an electric mixer 71 to scramble and mix the oil which flows into the mixing tank 7 through the pipe 35 from the separation tank 3, with the oil which is condensed through the second condenser 2A and drops into the mixing tank 7; whereas, the mixed oil can flow into the oil tank 36 through the oil drain pipe 35a. The system of this embodiment is further provided with an ultrasonic generator 8 which is not disclosed in the first embodiment. The ultrasonic generator 8 is provided at a bottom of the separation tank 3 to cut off and disintegrate polymer structures of the oil in the tank by an ultrasonic effect, so as to acquire more low-molecule light oil. The ultrasonic generator 8 can be operating at output power density of more than 50 w/cm³, and is preferably operating at 100-200 w/cm³ at 20 kHz. Cooling temperature of the second condenser 2A is set to be lower than that of the first condenser 2 and is usually set at below 15° C., to facilitate re-cooling the gas from the separation tank 3 as oil. An interior of the exterior tank 21 of the second condenser 2A is not formed with the gas gathering chamber 23, but only formed with the helical inner tube 22. This type of condenser is an ordinary conventional one. Other types of condensers can be used, of course. The exterior tank 21 is also provided with an inlet and an outlet for cooling fluid which can be cooling water or coolant.

When implementing the method for extracting the oil product by the aforementioned system, the operation and the reaction process from the reaction vessel 1 to the separation tank 3 are basically the same as those in the first embodiment, with an exception that the non-liquefied gas in the separation tank 3 is guided into the second condenser 2A for cooling once more with low temperature, such that part of the gas is condensed as oil which flows into the mixing tank 7 and is mixed with the oil from the separation tank 3 by the mixer 8 and is then gathered in the oil tank 6, whereas the still non-liquefied gas is discharged outside from the exhaust pipe P2. In short, the gas which is produced by carrying out the thermal pyrolysis cracking to the raw materials M under a vacuum and oxygen-free condition in the reaction vessel 1 flows into the first condenser 2, is cooled down as liquid and then flows into the separation tank 3. Polymer structures of heavy oil are cut off here by the ultrasonic effect generated by the ultrasonic generator 8, thereby increasing production of light oil. On the other hand, the non-liquefied gas is cooled down again by the second condenser 2A, allowing part of the gas to be condensed as oil to be stored in the mixing tank 7 and mixed with the oil from the separation tank 3, thereby increasing the amount of oil to be gathered and improving the quality. The non-liquefied gas in the mixing tank 7, whereas, is discharged outside by the suction pump 4. Upon implementing this method, the way that the control booth 5 and the pump 4 control in phases temperature in the reaction vessel 1 and suck out air to reduce pressure at any time is similar to that in the first embodiment. Therefore, it will not be addressed further to avoid repetition. After one cycle of thermal pyrolysis cracking process has been accomplished, in addition to that the oil tank 7 can acquire more and higher quality oil products than the first embodiment, the reaction vessel 1 can also acquire high value activated carbons.

Furthermore, in the present embodiment, the suction pump 4 can be also provided midway in the exhaust pipe P1, i.e., an upstream end of the second condenser 2A, as in the first embodiment.

Referring to FIG. 3, it shows a third embodiment of the present invention. This system is physically identical to the system of the first embodiment, except that at the outlet port of the condenser 2 (i.e. the inlet port of the separation tank 3), the exhaust pipe P is connected to a reverse tube p, an upper end of which is connected to an upstream end of the exhaust pipe P (i.e. the inlet port of the condenser 2). Therefore, the non-liquefied gas will flow reversely to the exhaust pipe P through this reverse tube p, merge with the distilled gas and then flow into the condenser 2 for condensation, so as to increase the amount of oil that is gathered. In addition, the bottom of the separation tank 3 is also provided with the ultrasonic generator 8, a function of which is same as that in the first embodiment.

The operation process by which the raw wastes are undergone with the thermal pyrolysis cracking process to make the oil with the aforementioned system is physically the same as that in the first embodiment, except that part of the non-condensed and non-liquefied gas will flow reversely to the condenser 2 for condensation again, in order to increase the amount of oil to be gathered. To avoid repetition, the description is not provided further.

Hereinbefore are descriptions to the preferred embodiments of the present invention, and all kinds of modifications and alterations can be still made without violating the principles and characteristics of the present invention. For example, the separation tank 3 of the system in the first embodiment can be provided with the ultrasonic generator 8, and in the system of the second embodiment, the oil of the separation tank 3 and the mixing tank 7 can be gathered separately without mixing. At this time, the oil drain pipe with two outlets (not shown in the drawings) should be provided with a bi-directional switch valve to guide the oil into the mixing tank or another oil tank. These should be taken as being covered in the following claims.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of extracting essential oil from biomass wastes, comprising following steps:
a. heating up indirectly biomass raw wastes in an air-tight reaction vessel, an interior of which is kept at low vacuum and is oxygen-free, to produce a thermal pyrolysis cracking (i.e. dry distillation) reaction;
b. guiding smoky gas which is distilled from executing the thermal pyrolysis cracking to the aforementioned raw materials into a condenser to condense as liquid;
c. guiding the aforementioned condensate into a separation tank to separate into water and oil; and
d. discharging outside non-liquefied gas which has been undergone with the aforementioned condensation and separation steps, by a suction pump;
whereas in implementing the aforementioned steps, temperature and pressure of the reaction vessel being divided into at least two phases for control which includes automatically or manually controlling the aforementioned suction pump to execute short and high-speed suction in a large amount timely, so as to allow the thermally disintegrated gas not to remain in the reaction vessel for too long that ingredient is reconstituted, and to keep at all time internal pressure of the reaction vessel at a pre-determined low pressure condition.

2. The method according to claim 1, wherein in the thermal pyrolysis cracking step, the internal pressure of the reaction vessel is kept at below 1 kg/cm².

3. The method according to claim 1 or 2, wherein in the thermal pyrolysis cracking step, the internal pressure of the reaction vessel is kept at 0.5-0.8 kg/cm².

4. The method according to claim 1, wherein in the thermal pyrolysis cracking process, the temperature control is divided into several phases from 130° C. to over 500° C. and is preferably divided into three phases.

5. The method according to claim 1 or 4, wherein the separation step includes using an ultrasonic generator at the separation tank to cut off polymers in liquid inside the separation tank.

6. A method of extracting essential oil from biomass wastes, comprising following steps:
a. heating up indirectly biomass raw wastes in an air-tight reaction vessel, an interior of which is kept at low vacuum and is oxygen-free, to produce a thermal pyrolysis cracking (i.e. dry distillation) reaction;
b. guiding smoky gas which is distilled from executing the thermal pyrolysis cracking to the aforementioned raw materials into a first condenser to condense as liquid;
c. guiding the aforementioned condensate into a separation tank to separate into water and oil;
d. guiding non-liquefied gas from the aforementioned condensation and separation steps into a second condenser for cooling at temperature lower than that of the first condenser, allowing part of the gas to be re-condensed as liquid;
e. guiding the liquid which is condensed through the second condenser into a mixing tank and mixing the liquid with oil in the aforementioned liquid which is guided into the mixing tank from the aforementioned separation tank; and
f. discharging outside non-liquefied gas in the aforementioned mixing tank by a suction pump;
whereas in implementing the aforementioned steps, temperature and pressure of the reaction vessel being divided into at least two phases for control which includes automatically or manually controlling the aforementioned suction pump to execute short and high-speed suction in a large amount timely, so as to allow the thermally disintegrated gas not to remain in the reaction vessel for too long that ingredient is reconstituted, and to keep at all time internal pressure of the reaction vessel at a pre-determined low pressure condition.

7. The method according to claim 6, wherein in the thermal pyrolysis cracking step, the internal pressure of the reaction vessel is kept at below 1 kg/cm².

8. The method according to claim 6, wherein in the thermal pyrolysis cracking step, the internal pressure of the reaction vessel is kept at 0.5˜0.8 kg/cm².

9. The method according to claim 6, wherein in the thermal pyrolysis cracking process, the temperature control is divided into several phases from 130° C. to over 500° C. and is preferably divided into three phases.

10. The method according to claim 6, wherein the separation step includes using an ultrasonic generator at the separation tank to cut off polymers in liquid inside the separation tank.

11. A device for extracting essential oil from biomass wastes, comprising:
a. a reaction vessel having an external vessel, an outer peripheral wall of which is provided with an electro-thermal device and a thermal insulation humectant; and an inner vessel which is removably emplaced in the external vessel to hold raw materials;
b. a condenser which is provided at a downstream side of the reaction vessel to condense gas distilled from the aforementioned reaction vessel;
c. a separation tank which is provided at a downstream side of the condenser to separate liquid condensed from the condenser into water and oil;
d. a suction pump which is provided at a downstream side of the separation tank to discharge non-condensed and non-liquefied gas out of the system; and
e. a control booth which is used to adjust and control temperature and pressure in the reaction vessel and is connected to the aforementioned suction pump.

12. The device according to claim 11, wherein a bottom of the separation tank is further provided with an ultrasonic generator.

13. The device according to claim 11, wherein a place close to an outlet of the condenser is further connected with a reverse tube, an end of which is connected with the condenser.

14. A device for extracting essential oil from biomass wastes, comprising:
a. a reaction vessel having an external vessel, an outer peripheral wall of which is provided with an electro-thermal device and a thermal insulation humectant; and an inner vessel which is removably emplaced in the external vessel to hold raw materials;
b. a first condenser which is provided at a downstream side of the reaction vessel to condense gas distilled from the aforementioned reaction vessel;
c. a separation tank which is provided at a downstream side of the first condenser to separate liquid condensed from the condenser into water and oil;
d. a second condenser which is provided at a downstream side of the separation tank to re-condense non-condensed and non-liquefied gas from the first condenser;
e. a mixing tank which is provided at a downstream side of the second condenser to mix liquid condensed by the second condenser with liquid condensed by the first condenser and from the separation tank;
f. a suction pump which is provided at a downstream side of the mixing tank to discharge non-condensed and non-liquefied gas out of the system; and
g. a control booth which is used to adjust and control temperature and pressure in the reaction vessel and is connected to the aforementioned suction pump.

15. The device according to claim 14, wherein a bottom of the separation tank is further provided with an ultrasonic generator.
